(19) United States
(12) Patent Application Publication
(10) Pub. No.: US 2002/0096927 A1
(43) Pub. Date: Jul. 25, 2002

(54) Foldable backrest of electric cart

(76) Inventor: Tsang-Ying Chen, Chang Hua Hsien (TW)

Correspondence Address: BROWDY AND NEIMARK, P.L.L.C., 624 NINTH STREET, NW, SUITE 300, WASHINGTON, DC, 20001-5303, US

(21) Appl. No.: 09/767,712

(22) Filed: Jan. 24, 2001

(51) Int. Cl. B60N 2/20

(52) U.S. Cl. 297/378.1; 297/378.12

(57) ABSTRACT

A backrest folding structure of an electric cart seat is formed of a first tubular member connected to the seat backrest, a second tubular member connected to the seat main body, a retaining member slidably disposed in the first tubular member, and an elastic member disposed in the first tubular member to provide the retaining member with a spring force enabling the retaining member to be partially jutted out of the first tubular member. The first tubular member and the second tubular member are pivoted together such that they are located at an unfolding position at such time when the retaining member is extended into the second tubular member, and that they are located at a folding position at the time when the retaining member is slid back into the first tubular member.

### FIELD OF THE INVENTION

The present invention relates generally to an electric cart, and more particularly to a foldable backrest of the seat of the electric cart.

### BACKGROUND OF THE INVENTION

The conventional electric cart is generally provided with a backrest which is fixed. The fixed backrest makes the electric cart so cumbersome that the electric cart can not be easily shipped or stored.

### SUMMARY OF THE INVENTION

The primary objective of the present invention is to provide an electric cart with a seat having a foldable backrest to facilitate the shipping or the storing of the electric cart.

The foldable backrest of the present invention comprises a first tubular member, a second tubular member, a retaining member, and an elastic member. The first and the second tubular members are connected with the seat main body and are pivoted together. The first and the second tubular members can be swiveled between an unfolding position and a folding position. The retaining member is slidably disposed in the first tubular member such that the retaining member can be extended into the second tubular member so as to keep the backrest in an unfolding state at the time when the retaining member is slid outward. As the retaining member is slid inward, the first and the second tubular members are kept in a folding state. The retaining member is provided with a spring force by the elastic member which is disposed in the first tubular member, thereby enabling the retaining member to be partially jutted out of the first tubular member at the time when the retaining member is located at its initial position.

### BRIEF DESCRIPTION OF THE DRAWINGS

FIG. 1 shows an exploded view of the present invention.

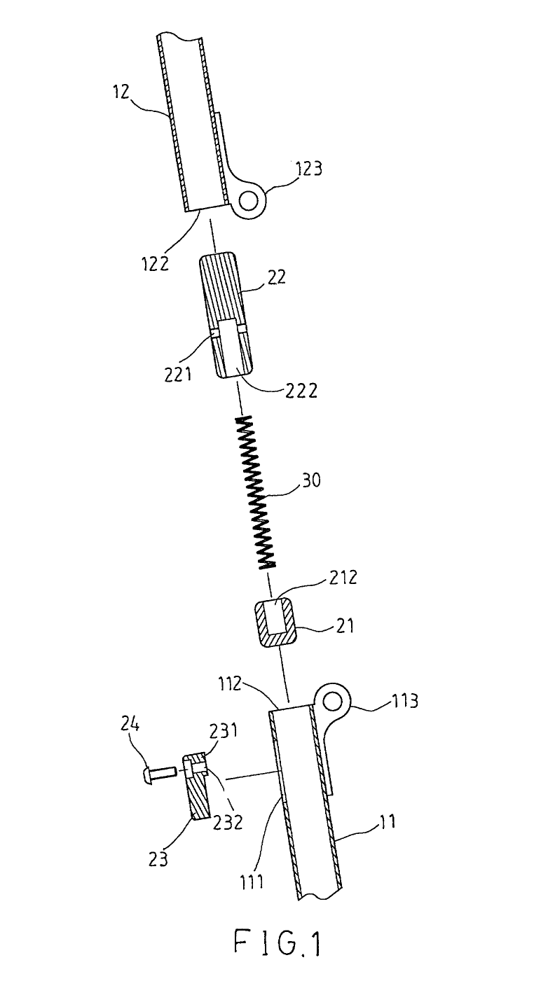

FIG. 2 shows a sectional view of the present invention in combination.

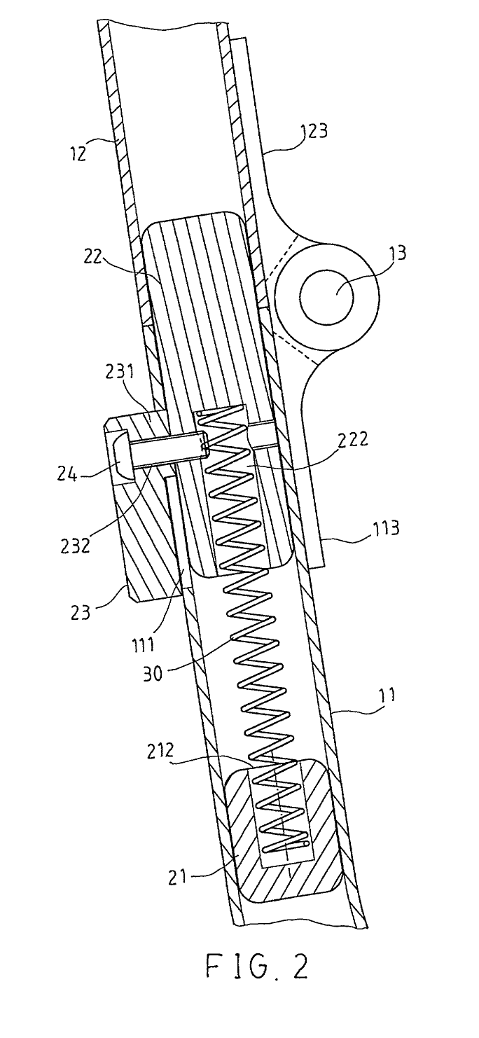

FIG. 3 shows a schematic view of the present invention.

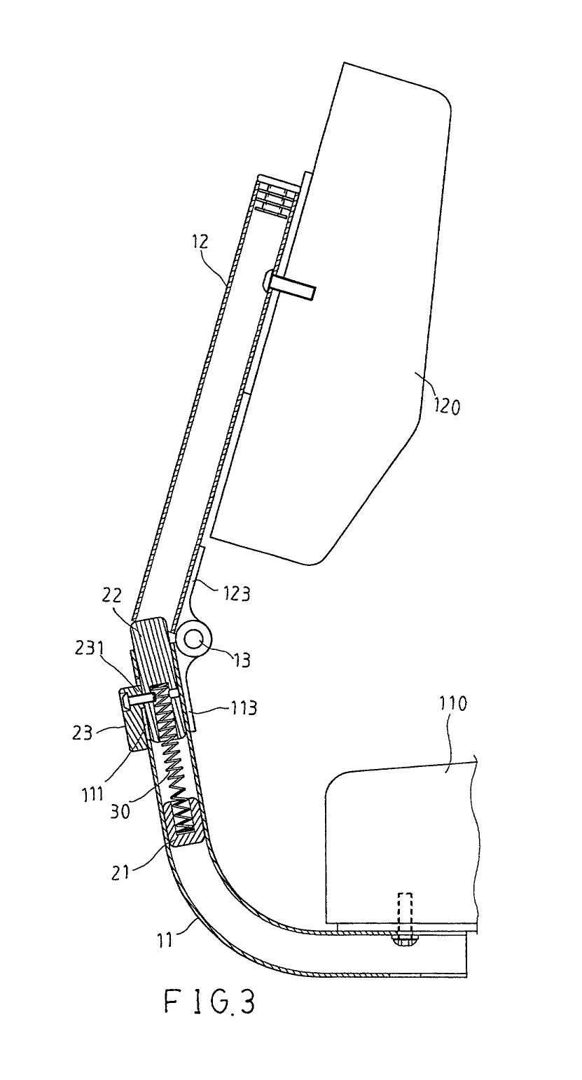

FIG. 4 shows a schematic view of the present invention at work.

FIG. 5 shows a sectional view of the present invention in the unfolding state.

FIG. 6 shows a sectional view of the present invention in the folding state.

### DETAILED DESCRIPTION OF THE INVENTION

As shown in all drawings provided herewith, a foldable backrest of the present invention is mounted on an electric cart 100 and is formed of the component parts which are described hereinafter.

A curved first tubular member 11 is fastened at one end with a seat main body 110 of the electric cart 100. The first tubular member 11 is provided with a through hole 111 and a fastening member 21, which is retained in the curved portion of the first tubular member 11 and is provided with a slot 212. A second tubular member 12 is connected with a backrest 120. The first tubular member 11 and the second tubular member 12 are respectively provided with a pivoting end 112, 122, and a pivoting portion 113, 123 located in proximity of the pivoting end. The first and the second tubular members 11 and 12 are pivoted together by a pivot 13 which is put through the pivoting portions 113 and 123. As a result, the first and the second tubular members 11 and 12 can be swiveled between an unfolding position in contact with the pivoting ends 112 and 122, and a folding position separating from the pivoting ends 112 and 122. As the first and the second tubular members 11 and 12 are located at the folding position, the backrest 120 is rested against the seat main body 110 of the electric cart 100.

A retaining member 22 is provided with a threaded hole 221, and a slot 222 located at one end thereof. The retaining member 22 is disposed in the first tubular member 11 such that the threaded hole 221 is corresponding in location to the through hole 111 of the first tubular member 11. A grip member 23 is provided with a protruded portion 231 and a through hole 232. The grip member 23 is fastened with the retaining member 22 by a fastening screw 24 which is engaged with the threaded hole 221 of the retaining member 22 via the through hole 232 of the grip member 23. The protruded portion 231 of the grip member 23 is received in the through hole 111 of the first tubular member 11. The retaining member 22 is moved when the grip member 23 is exerted on by an external force. In light of the action of the protruded portion 231 of the grip member 23, the retaining member 22 can be moved only within the confine of the through hole 111 of the first tubular member 11.

An elastic member 30 is a compression spring, which is disposed in the first tubular member 11 such that one end of the compression spring 30 is received in the slot 222 of the retaining member 22, and that other end of the compression spring 30 is received in the slot 212 of the fastening member 21, so as to provide the retaining member 22 with a spring force enabling one end of the retaining member 22 to be jutted out of the pivoting end 112 of the first tubular member 11 at such time when the retaining member 22 is located at an initial position.

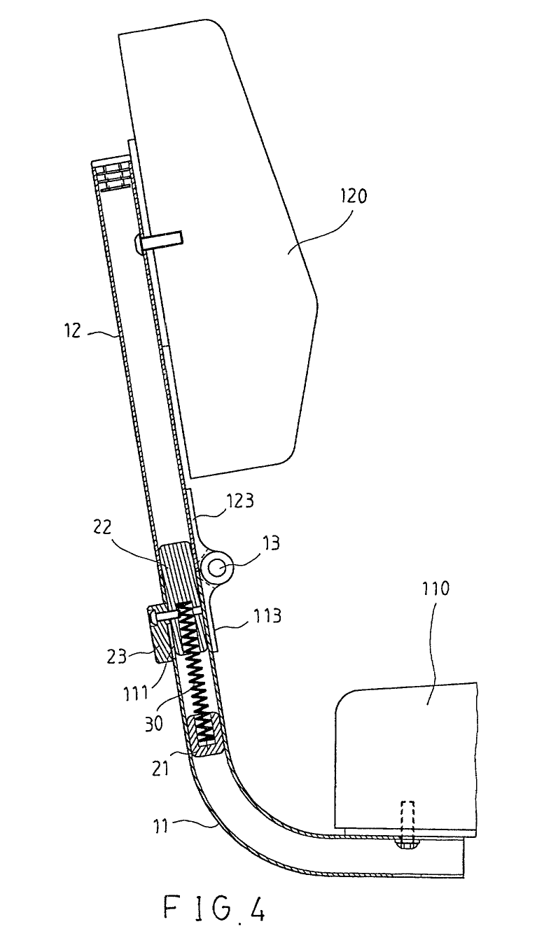

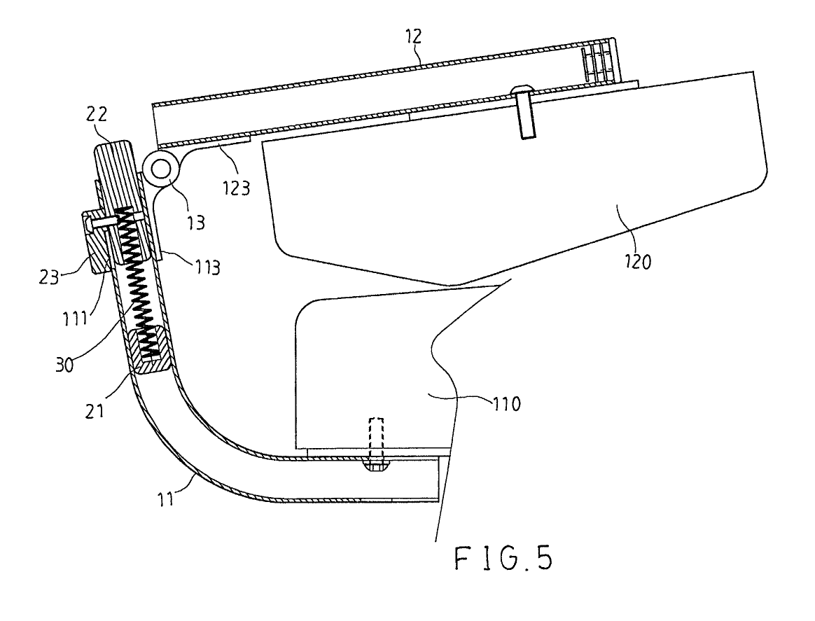

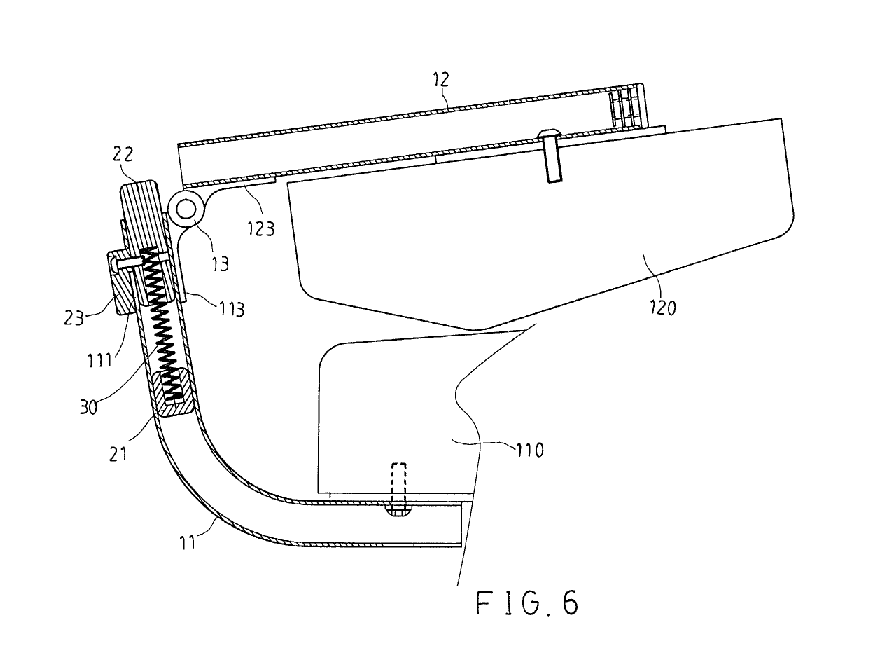

As shown in FIG. 4, when the second tubular member 12 is swiveled to the unfolding position, the pivoting end 122 of the second tubular member 12 forces the retaining member 22 to move inward. In light of the spring force of the compression spring 30, a portion of the retaining member 22 is forced into the second tubular member 12, which is thus located securely at the unfolding position as shown in FIG. 5. When the grip member 23 is exerted on by an external force, the retaining member 22 is moved inward, thereby enabling the second tubular member 12 to be swiveled to the folding position as shown in FIG. 6.

The retaining member 22, the grip member 23, the fastening member 21, and the elastic member 30 may be disposed in the second tubular member 12 which is connected to the backrest 120.

What is claimed is:

1. A folding structure of the seat backrest of an electric cart, said folding structure comprising:
a first tubular member and a second tubular member for connecting the backrest with the seat main body of the electric cart, said first tubular member and said second tubular member being provided with a pivoting end and pivoted together such that said first tubular member and said second tubular member can be swiveled between an unfolding position and a folding position, said pivoting ends of said first tubular member and said second tubular member being in contact with each other at said unfolding position, and separated from each other at said folding position;
a retaining member slidably disposed in said first tubular member such that said retaining member is extended into said second tubular member at said unfolding position, and that said retaining member is slid back into said first tubular member at said folding position; and
an elastic member disposed in said first tubular member for providing said retaining member with a spring force enabling said retaining member to be partially jutted out of said pivoting end of said first tubular member at such time when said retaining member is located at an initial position.

2. The folding structure as defined in claim 1, wherein said first tubular member is provided with a through hole and a grip member whereby said grip member is connected with said retaining member by a connection member which is put through said through hole of said first tubular member.

3. The folding structure as defined in claim 2, wherein said through hole of said first tubular member has a predetermined length; wherein said retaining member is slidable only within the confine of the length of said through hole of said first tubular member.

4. The folding structure as defined in claim 3, wherein said grip member is provided with a protruded portion whereby said protruded portion is disposed in said through hole.

5. The folding structure as defined in claim 1, wherein said first tubular member is provided with a fastening member; wherein said elastic member is disposed in said first tubular member such that one end of said elastic member urges said fastening member, and that other end of said elastic member urges said retaining member.

6. The folding structure as defined in claim 5, wherein said fastening member is provided with a slot; wherein said one end of said elastic member is disposed in said slot of said fastening member.

7. The folding structure as defined in claim 1, wherein said retaining member is provided with a slot; wherein one end of said elastic member is disposed in said slot of said retaining member.

8. The folding structure as defined in claim 1, wherein said elastic member is a compression spring.

9. The folding structure as defined in claim 1, wherein said first tubular member and said second tubular member are provided with a pivoting portion whereby said pivoting portion is located in proximity of said pivoting end; wherein said first tubular member and said second tubular member are pivoted together by a pivot which is put through said pivoting portions.

10. The folding structure as defined in claim 1, wherein said first tubular member is connected to the seat backrest, whereas said second tubular member is connected to the seat main body.

11. The folding structure as defined in claim 1, wherein said second tubular member is connected to the seat backrest, whereas said first tubular member is connected to the seat main body.
